(19) United States
(12) Patent Application Publication
(10) Pub. No.: US 2015/0302494 A1
(43) Pub. Date: Oct. 22, 2015

(54) METHODS AND SYSTEMS OF USER INTERFACE AND COMPUTATION OF CONTRACTS

(71) Applicant: Muhammad AL DAWOOD, Stanford, CA (US)

(72) Inventor: Muhammad AL DAWOOD, Stanford, CA (US)

(21) Appl. No.: 14/256,060

(22) Filed: Apr. 18, 2014

(51) Int. Cl. G06Q 30/06; G06Q 50/16

(52) U.S. Cl. CPC G06Q 30/0609; G06Q 50/16

(57) ABSTRACT

Methods and systems include a computer-implemented method of forming a contract between two or more parties. The method includes receiving contract-related events and states of the contract-related events from a user, via a graphical user interface (GUI). The method also includes developing a set of possibilities for the states of the contract-related events for associated time periods and properties between contracting parties. The method also includes defining a transaction for each possibility and its associated time period and property, and returning results of the developing and the defining to the user. The returned results can be displayed to the user in a table format or a flow chart format.

### GRANT OF NON-EXCLUSIVE RIGHT

This application was prepared with financial support from the Saudia Arabian Cultural Mission, and in consideration therefore the present inventor(s) has granted The Kingdom of Saudi Arabia a non-exclusive right to practice the present invention.

### BACKGROUND

A contract is a deterministic function that maps mutually exclusive and collectively exhaustive future possibilities to a specified transfer of property of different kinds between contracting parties. In practice, contracts often include many events and represent a long term relationship between contracting parties. However, such contracts can be difficult to construct and communicate.

Conventionally written contracts are difficult to understand for many people. It is also difficult for a non-legal layperson to design and negotiate a contract. In addition, companies with several active contracts may find it difficult to manage and track those contracts without extensive legal counsel.

### SUMMARY

Embodiments include a computer-implemented method of forming a contract between two or more parties. The method includes receiving contract-related events and states of the contract-related events from a user, via a graphical user interface (GUI). The method also includes developing a set of possibilities for the states of the contract-related events for associated time periods and properties between contracting parties. The method also includes defining a transaction for each possibility and its associated time period and property, and returning results of the developing and the defining to the user in a contract table or a contract flow chart.

Embodiments also include a computer-implemented method of developing a contract flow chart. The method includes receiving one or more contract-related events from a user via a GUI of a computing device. The method also includes ordering the received one or more contract-related events along a first path of a time dimension according to an associated time of resolution between contracting parties in a contract flow chart. The method also includes embedding an instruction to resolve or determine an outcome within each associated contract-related event. The method also includes outputting one or more specific property transfers along the time dimension after its associated contract-related event has been resolved in the contract flow chart, and indicating an end of contract along the time dimension in the contract flow chart.

Embodiments also include a contract creation computing system. The contract creation computing system includes a processing server containing a combination of hardware and software components to process contract data between contracting parties. The contract data contains one or more contract-related events that are positioned along a time line dimension according to an associated time of resolution by the processing server from a start of a contract to an end of the contract between the contracting parties. The contract creation computing system also includes a database storing the contract data sent to and received from the processing server, and a computing client machine having a GUI to input the contract data and to receive results of the processing server. One or more specific property transfers between the contracting parties for a specific unit of property are outputted along the time line dimension after its associated contract-related event, via the processing server.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates a network used to implement the embodiments described herein;

FIG. 2 illustrates a possibility tree according to one example;

FIGS. 3A-3C illustrate flow charts according to some examples;

FIG. 4 is a flow chart for a convertible note according to one example;

FIG. 5 is a flow chart for a series investment contract according to one example;

FIG. 6 is a block diagram of a computing system used to implement the embodiments described herein according to some examples;

FIG. 7 is a flow diagram for a computer-implemented method of forming a contract between two or more parties according to one example; and

FIG. 8 is a flow diagram for a computer-implemented method of developing a contract flow chart according to one example.

Referring now to the drawings, wherein like reference numerals designate identical or corresponding parts throughout the several views.

### DETAILED DESCRIPTION OF THE EMBODIMENTS

Contracts are currently communicated using written documents, typically organized as clauses or sections. This representation is not very user-friendly and can be very difficult to understand, especially for contracts that include many events and span a long time interval. A computer-based system and method to develop and communicate contracts is presented herein.

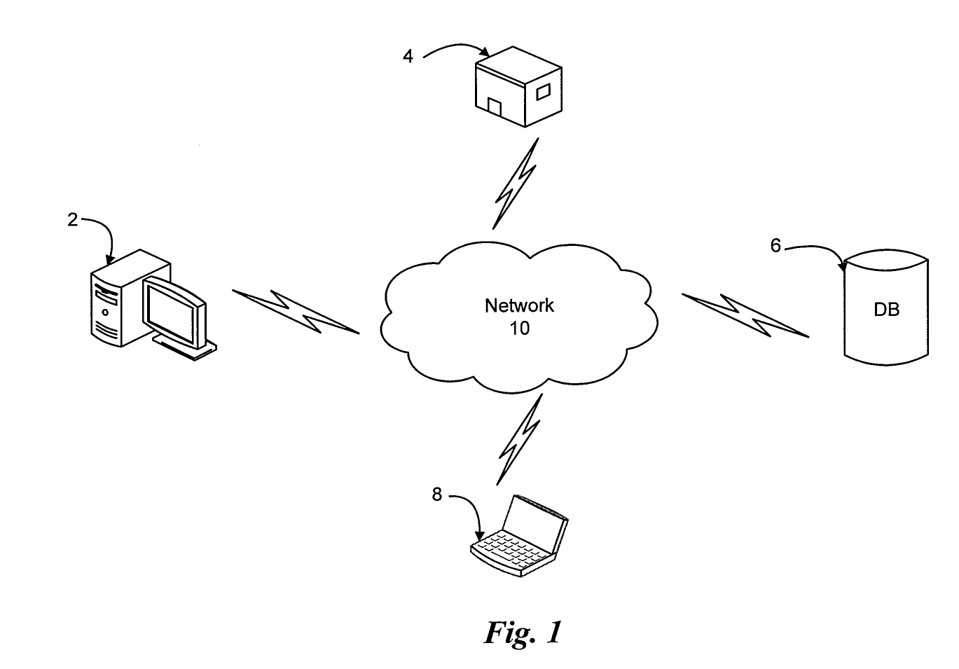

FIG. 1 illustrates a networking system by which a contract creation computing system is implemented. A server 4 contains a combination of hardware and software components in which requests from one or more client machines is processed and returned. FIG. 1 illustrates two types of client machines of a computer 2 and a mobile device 8. A database 6 stores data used by the server in the contract creation computing system. Even though only one server 4, one computer 2, one mobile device 8, and one database 6 are illustrated, any number of each is contemplated by embodiments herein. All of the server 4, computer 2, mobile device 8, and database 6 are interconnected by means of a network 10. The network 10 could be the Internet, a local area network, or a wide area network.

A contract is a deterministic function, and can in selected embodiments be represented and stored in a computer device as a table. In an embodiment, a contract table contains rows, columns, and cells. The rows constitute a set of mutually exclusive and collectively exhaustive possibilities, or scenarios. The possibilities are represented along a time dimension by all distinctions or events included in a contract. Each possibility is a future eventuality from the beginning to the end of the life of the contract. The contract ends when all of the events included in the contract are resolved.

The columns of a contract table show the property kinds that are supplied by the contracting parties, which are to be transferred between the contracting parties within a specified period of time. The time dimension beneath each property kind shows the time frame within which a particular property kind is supposed to be transferred during the life of the contract. Many contract tables will have multiple time periods for the same type of property kind. For example, compensation may be transferred from a first contracting party to a second contracting party as specified work is completed throughout the life of the contract.

The cells of a contract table show the transfer of the title to a given property for a given particular future possibility. The transfer can be a function of an event, especially if the event is a continuous variable, such as the price of oil.

An event is a division of eventuality into mutually exclusive and collectively exhaustive states, where the number of states is the number of degrees of an event. In the context of a contract, events can be of two different kinds. The first kind is a contracting party's action of doing or not doing something. For example, a contracting party's action may be to provide electrical work to a new building. The second kind of event includes all other types of events.

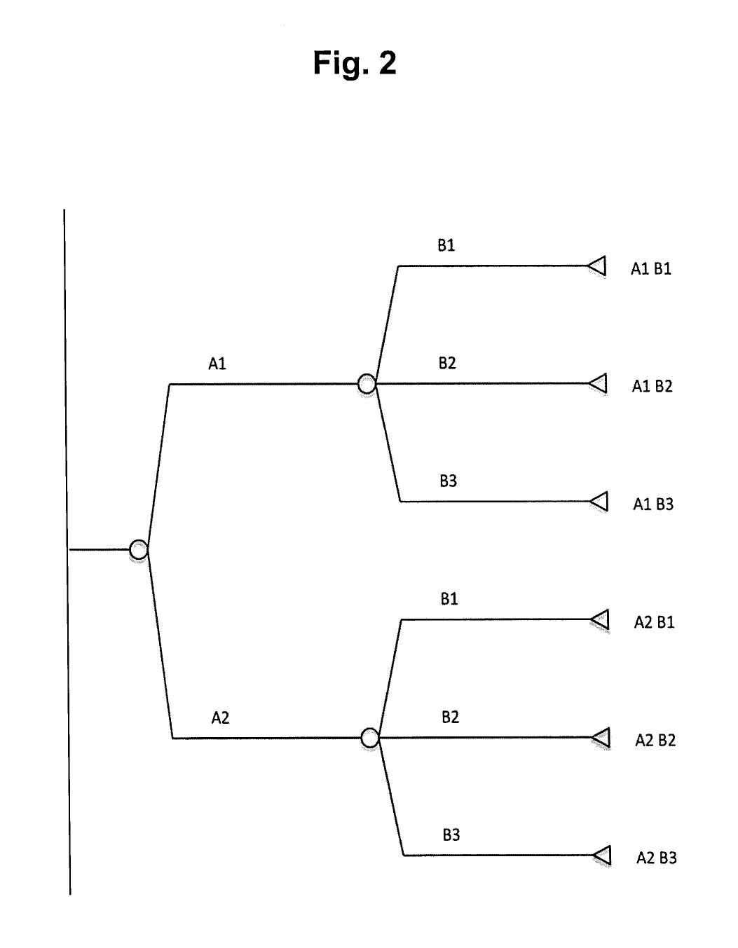

Each event has two or more degrees or states. FIG. 2 illustrates an exemplary possibility tree generated by the contract creation computing system, in which there are two events, A and B. Event A has two degrees or states and event B has three degrees or states, giving a total of six joint possibilities.

The table below is an example of a contract table, as described by embodiments herein.

TABLE 1
Sample Contract Table

| | Property 1 | Property 2 | Property 1 |
|---|---|---|---|
| | (money) | (house) | (money) |
| Possibilities | t0 ≦ t ≦ t1 | t0 ≦ t ≦ t1 | t1 ≦ t ≦ t2 |
| A1B1 | X → Y | 0 | Y → X |
| | units | | units |
| A1B2 + A1B3 | X → Y | 0 | 0 |
| | units | | |
| A2B1 + A2B2 | 0 | Y → X | X → Y |
| | | units | units |
| A2B3 | 0 | Y → X | 0 |
| | | units | |

Table 1 is a contract table built according to the possibility tree as shown in FIG. 2. There are two events, A and B, where event A has two states and event B has three states. There are two property types being exchanged, Property 1 (money) and Property 2 (house), and there are two time periods, t₀-t₁ and t₁-t₂. Some of the individual cells contain X→Y or Y→X, illustrating that the particular property will be transferred from X to Y or from Y to X, respectively. The “units” designation denotes the particular property that will be transferred. For example, under the money property type, a specific amount of money for that transfer would be entered. Likewise, under the house property type, a designation pertaining to that transfer would be entered, such as “deed transfer.”

Some joint possibilities can be combined to form a compounded possibility using an OR logical statement, such as A₁B₂+A₁B₃. This illustrates that, according to the contract, the two joint possibilities will result in the same property transfer. In short, the rows of the table constitute mutually exclusive and collectively exhaustive possibilities. FIG. 2 shows six joint possibilities constructed from events A and B. The rows of Table 1 were constructed from these possibilities. Joint possibilities A₁B₂ and A₁B₃ were combined to form the compounded possibility A₁B₂+A₁B₃, and joint possibilities A₂B₁ and A₂B₂ were combined to form the compounded possibility A₂B₁+A₂B₂.

A zero contained within a cell designates that there would not be a transfer of the corresponding property given for the corresponding possibility. An empty cell would designate that the contracting parties have left this portion of the contract unspecified, which should be a sign of error in the contract. As an alternative to an empty cell, the contracting parties can delegate the specification of the property transfer to a court or a dispute resolution entity.

Table 2 below lists some of the parameters of events, property, time periods, states, and parties, illustrating an example of painting a building. The contract builds on the possibility tree shown in FIG. 2.

TABLE 2
Defining Parameters of Painting Contract Table

| | Events | | Property | | Time Periods |
|---|---|---|---|---|---|
| A | Weather | P1 | Money | t = t₀-t₁ | First paint job |
| B | House painted? | | | t = t₁-t₂ | Extended rain |
| | | | | | dates |
| | | | | t > t₂ | Late date |
| | States | | | | Parties |
| A1 | Sunny | | | X | Owner |
| A2 | Rainy | | | Y | Contractor/painter |
| B1 | Met all | | | | |
| | conditions by the | | | | |
| | specified | | | | |
| | deadline | | | | |
| B2 | Completed with | | | | |
| | five or less | | | | |
| | weeks of delay | | | | |
| B3 | Not completed | | | | |
| | after five weeks | | | | |
| | from the | | | | |
| | specified | | | | |
| | deadline | | | | |

Based upon the parameters above, the following contract table can be formed. For the sake of brevity, compound possibilities have not been included.

TABLE 3
Painting Contract Table

| | P₁ | P₁ | P₁ |
|---|---|---|---|
| Possibilities | t₀-t₁ | t₁-t₂ | t₂ |
| A₁B₁ | X →Y | 0 | 0 |
| | $10K | | |
| A₁B₂ | 0 | X →Y | 0 |
| | | $5K | |
| A₁B₃ | 0 | 0 | Y →X |
| | | | $3K |
| A₂B₁ | X →Y | | 0 |
| | $10K | | |
| A₂B₂ | 0 | X →Y | 0 |
| | | $10K | |
| A₂B₃ | 0 | 0 | Y →X |
| | | | $3K |

The above table indicates that payment of $10,000 will be transferred from the owner X to the contractor/painter Y for a satisfactory completion of the painting contract. A payment of $10,000 would also be transferred for a satisfactory completion of the painting contract that was delayed due to rain. However, only a partial payment of $5000 will be transferred if the work is completed late, aside from bad weather. The contractor/painter Y will pay a penalty of $3,000 if the work is not completed by the late date (five weeks after the specified deadline). Table 3 can be rewritten to illustrate the use of compounded possibilities. In this case, possibilities A₁B₁ and A₂B₁ will result in the same property transfer. Therefore, they are presented as one row in the contract table. Also, possibilities A₁B₃ and A₂B₃ will result in the same property transfer. Therefore, they are presented as one row in the contract table. Table 3 above and Table 4 below illustrate the same transactions. Table 4 is a different way of visualizing the information and storing the table more efficiently.

TABLE 4
Painting Contract Table

| | P₁ | P₁ | P₁ |
|---|---|---|---|
| Possibilities | t₀-t₁ | t₁-t₂ | t₂ |
| A₁B₁ + A₂B₁ | X →Y | 0 | 0 |
| | $10K | | |
| A₁B₂ | 0 | X →Y | 0 |
| | | $5K | |
| A₁B₃ + A₂B₃ | 0 | 0 | Y →X |
| | | | $3K |
| A₂B₂ | 0 | X →Y | 0 |
| | | $10K | |

Table 3 or Table 4 above could be completed by one or both of the contracting parties, the owner and the contractor/painter, or a third party facilitating the contracting process such as a lawyer, a provider of contract management software, and others. The contract creation computing system would prompt the user(s) to define certain criteria, such as the parameters listed in Table 2. In this example, the events are Event A (weather) and Event B (house painting). The user(s) would also be prompted to enter all applicable states, such as A₁-A₂ and B₁-B₃, and to enter any applicable compound possibilities. Other parameters, such as multiple time periods and property types are also entered. The contract table provides a tool for contracting parties to identify all relevant parameters and to correlate all possibilities from those parameters in an all-inclusive compact table format.

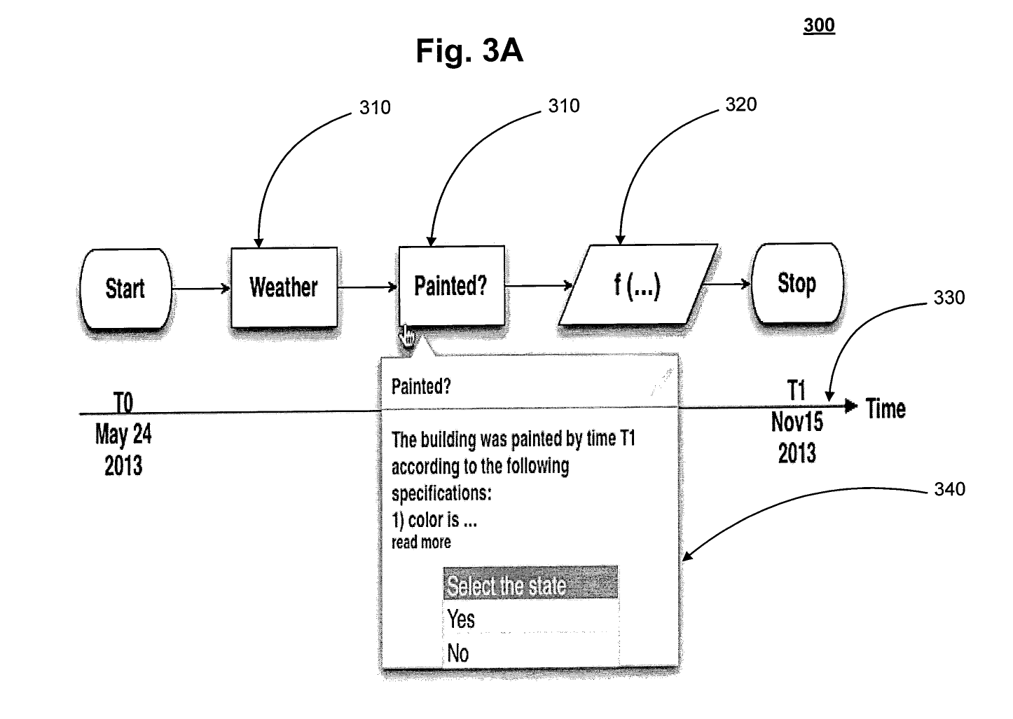

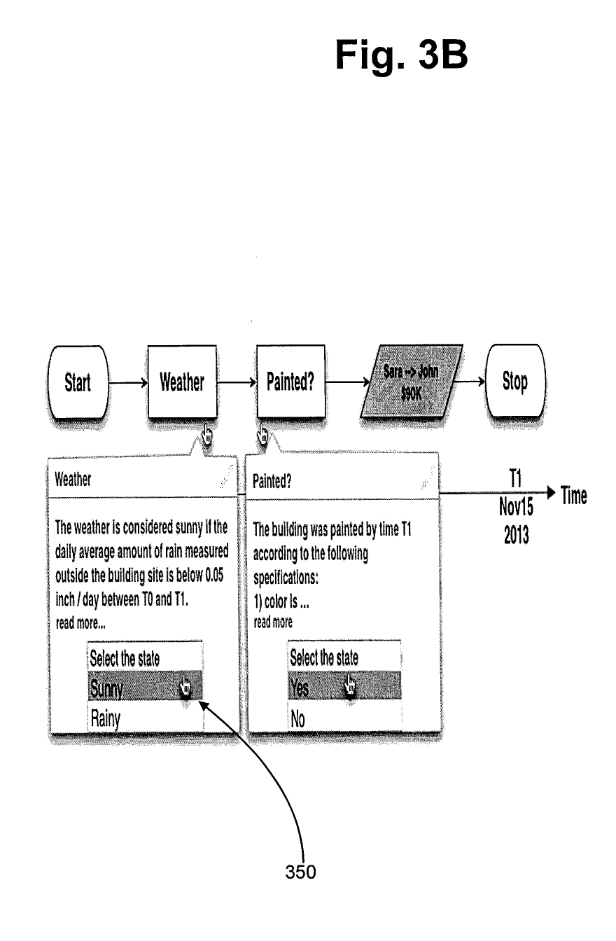

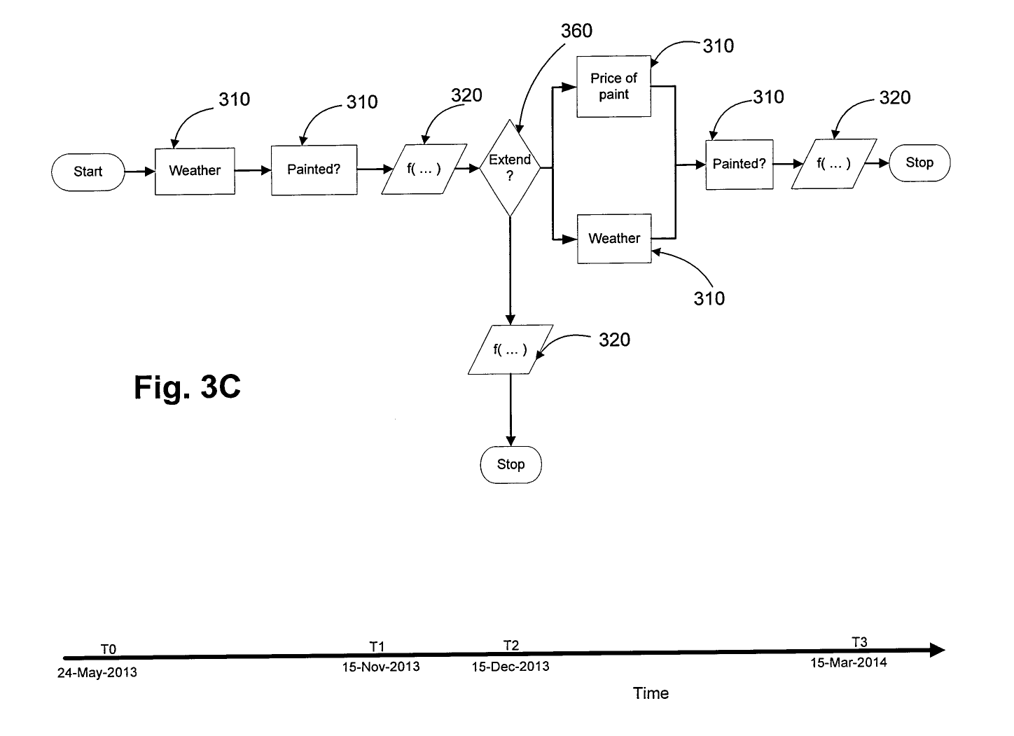

Other embodiments described herein utilize a flow chart of the contract events along a time line. The contract flow chart is a visualization tool that can serve as a platform for contract communication, design, and negotiation. It is constructed according to rules in order to represent and visualize contracts. FIG. 3A illustrates a simple contract flow chart. Contracting parties and supporting parties can communicate, design, and negotiate contracts on this platform. Users can design a contract using the systems and methods described herein by means of a graphical user interface (GUI).

Flow chart nomenclature of a rounded rectangle, a rectangle, a diamond, and a parallelogram is used. However, other flow chart nomenclature can be used without departing from the scope of the present disclosure. A rounded rectangle is an instruction to start or end the contract. The time line displays the start and the end of the contract. A rectangle is an instruction to resolve or determine the outcome of an event. A diamond is also an instruction to resolve an event, but is used for discrete events that produce asymmetry in the process, such as a decision in the contract process that will take different processing routes. A parallelogram displays the property transfer specified by the contract. This transfer is a function of some or all of the preceding resolution boxes, rectangle boxes, and diamond boxes. If the transfer takes place before the end of the contract, the time line should display the latest time in which this transfer should be made.

FIG. 3A illustrates a simple flow chart 300 for two events 310 and an associated transfer of property 320 within a single time period according to one example. The events need to be displayed in proper order with respect to the time line or time dimension 330. For example, in FIG. 3A, the weather event needs to be resolved before the painted event can be resolved. This has to do with the way these events are defined in this particular example. If two or more events 310 have no specific order, then they would be displayed in parallel, as one on top of another. After all of the events 310, a parallelogram illustrates the property to be transferred. For example, money would be transferred from the owner to the contractor upon satisfactorily painting the house when all of the events have been satisfied. FIG. 3A also illustrates an embedded detailed highlight 340 of an event when the user input pointer is pointed at the event box. In the example of FIG. 3A, details and a definition of the painted event are displayed, such as the color specifications and the required time of completion. The states for that particular event are also included.

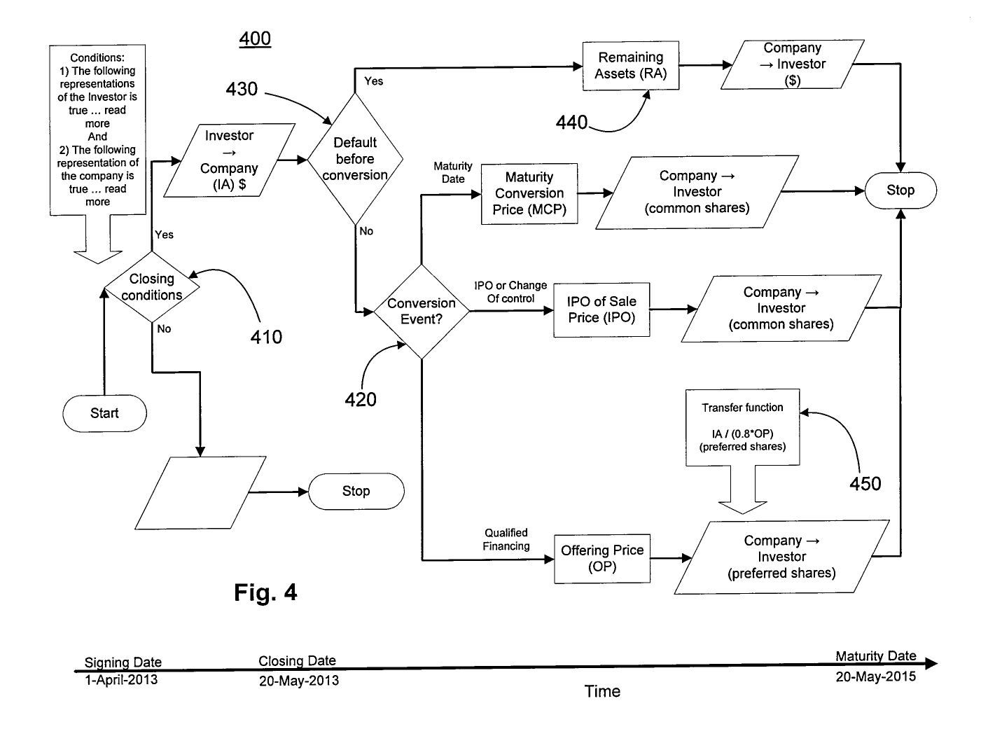

FIG. 3B illustrates that a selection 350 of a particular state can also be made by clicking on the appropriate state within the detailed event box of the flow chart according to one example. An embodiment of a GUI process to form a contract flow chart prompts a user for the following steps. A user will determine the events that are applicable to the particular contract to be created. The events can either be created by the user or they can be obtained from a software library. For each event, information is provided by the user, including but not limited to the name of the event, the type of event (discrete or continuous), the number of possibilities or states, the definition of each possible exclusive and collectively exhaustive outcome, and the earliest and latest date of resolution. These events will be ordered on the time line according to their time of resolution by the contract creation computing system working in the background. The time point of property transfer and the type of property to be transferred at each transfer point are also required input to a contract creation computing system. The contract creation computing system constructs a contract table with this information, such as the contract tables discussed above with respect to Tables 1-4. The contract creation computing system will prompt the user to specify the units and direction of property transfer at each transfer point. The contract creation computing system will also ensure that there is not any possibility for which property transfer is not specified, i.e. that no empty cells exist in the contract table. In an exemplary contract flow chart, a rectangle and a diamond represent events with defined states. When the user creates one of these boxes, the contract computing system will create a possibility tree similar to the one shown in FIG. 2 in the background, where events are ordered according to their time of resolution defined by the user. In a computer language, a tree is a sequence of logical statements (like A₁B₁, A₁B₁+A₂B₁ etc), which define the rows of the contract table as shown in Table 2 and Table 3 above. Moreover, when the user includes a parallelogram to indicate a point of property transfer conditioned on previous events, the contract computing system will create a column for each defined property type. Furthermore, when the user creates more events (a rectangle and a diamond) following the first parallelogram, the contract computing system will keep building the possibility tree in the background and adjusting the rows of the table. When the user adds a second parallelogram, the system will create additional column(s) to represent properties that will be exchanged in the second time interval. The contract computing system will prompt users to fill out the cells of the table by inputting values similar to FIG. 3B or functions of variables (events), such as 450 in FIG. 4 into the parallelogram. By using embodiments described herein, users can build extensive contracts without having to work with large possibility trees.

FIG. 3C illustrates a modified version of the flow chart illustrated in FIG. 3A. At the end of the time period T₀-T₁, a new event (the owner's decision 360 whether or not to extend the contract to include painting a second building) is included. The owner's decision must be made within the second time period T₁-T₂. If the decision 360 is affirmative, a third time period T₂-T₃ illustrates the events of the extended contract. There are two events to consider in the extended contract, illustrated as “price of paint” 310 and “weather” 310, which occur in parallel since there is no strict order of their time of resolution. The third event, “painted” 310 occurs after the other two events, and is therefore placed subsequently in the timeline. If the decision 360 is negative, i.e. the contract is not extended to include painting a second building, a transfer of property 320 occurs for the work completed during T₀-T₁, and the contract ends.

Embodiments described herein provide two different formats for formulating a contract. A contract table can be developed, such as the tables shown in Table 1 and 3 above in which all elements of a contract can be accounted for in a compact spreadsheet format. A contract flow chart can be utilized to aid the users in visualizing the flow of events as they occur in time. A contract flow chart is also advantageous for more complex contracts.

FIG. 4 is a flow chart 400 for a convertible note contract according to one example. A convertible note contract is often used for investments in early stage startups. The flow chart 400 shows that the capital is to be transferred from the investor to the startup only if certain closing conditions 410 are met. In exchange for the capital, the investor would receive a number of common or preferred shares, depending upon the conversion event 420. The states of the conversion event include qualified financing, IPO or change of control, or maturity date. If the startup defaults before a conversion event 430, the investor will receive a specific amount of the remaining asset 440. FIG. 4 illustrates that a computer-based implementation of the flow chart allows contract readers to point at the event boxes, rectangles, and diamonds 450 to read the transfer functions. Contracting parties can easily recognize the flexibility of generating variations of the same contract by changing the definitions of the different events or by changing the transfer functions.

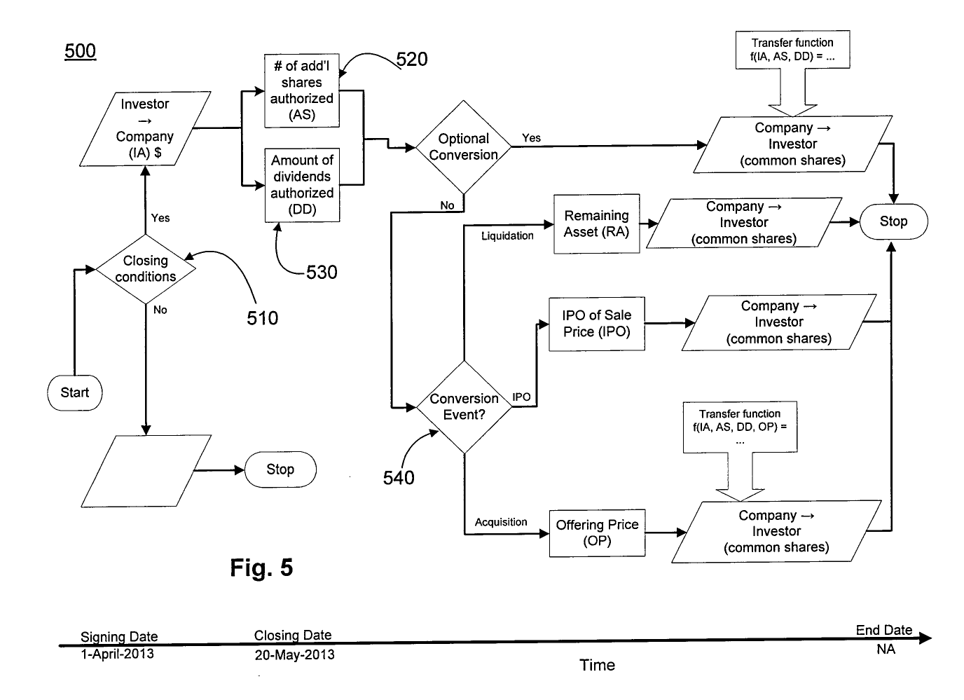

As a startup company grows, it goes through rounds or series of financing. Those series can be ordered alphabetically, such as series-A, series-B, etc. A seed financing often precedes these financing rounds. FIG. 5 is a flow chart 500 illustrating an exemplary Series-A investment contract. According to the contract flow chart 500, the capital will be transferred from the investor to the startup only if certain closing conditions 510 are met. A condition that may be required by investors is the adjustment of the company's charter, which might include configuring the board of directors and assigning decision rights, such that investors will have control over some corporate decisions like the valuation of the next round of financing and the sale of the company. The contract flow chart of FIG. 5 illustrates the investor will receive a number of common shares depending on the number of additional shares issued 520, the amount of dividends authorized 530, and the conversion event 540. The conversion event may include liquidation, IPO, or acquisition. The investor has the option to convert and receive common stock at a determined price before a conversion event. The contract is used to divide the company's rewards in different future possibilities between the founders and the investors, and also to assign decision rights that set the future direction of the company.

The flow charts described herein provide a visual and user-friendly tool to assist users with the creation of a contract, using the contract creation computing system. The flow charts use different types of boxes with specifically-defined meanings, all of which are imposed along a time line. Additional information can be obtained by clicking on one of the boxes. The flow charts display the proper order or succession of events, as well as alternative routes upon making a decision.

The contract flow charts can serve as a platform for contract design and negotiation by contracting parties and supporting parties. Using a graphical interface, users can design their own contract. The contract creation computing system has functionalities that help contracting parties increase the total value created from the transaction.

The contract tables and contract flow charts can also assist companies as a management tool. The order of events provides a timeline by which supplies and services are to be obtained, and when payments are due. The contract tables and flow charts give companies the ability to manage concurrent contractual relationships and visualize the flow of cash and other assets from multiple contracts. The contract creation computing system also allows companies to generate periodic statements of current assets and the range of future assets. As an example, the user can specify a date or a timeframe, and the contract creation computing system searches all the contracts for transfers that should take place before the specified date or within the specified timeframe. The contract tables and flow charts also allow a company to assign performance responsibilities to specific employees.

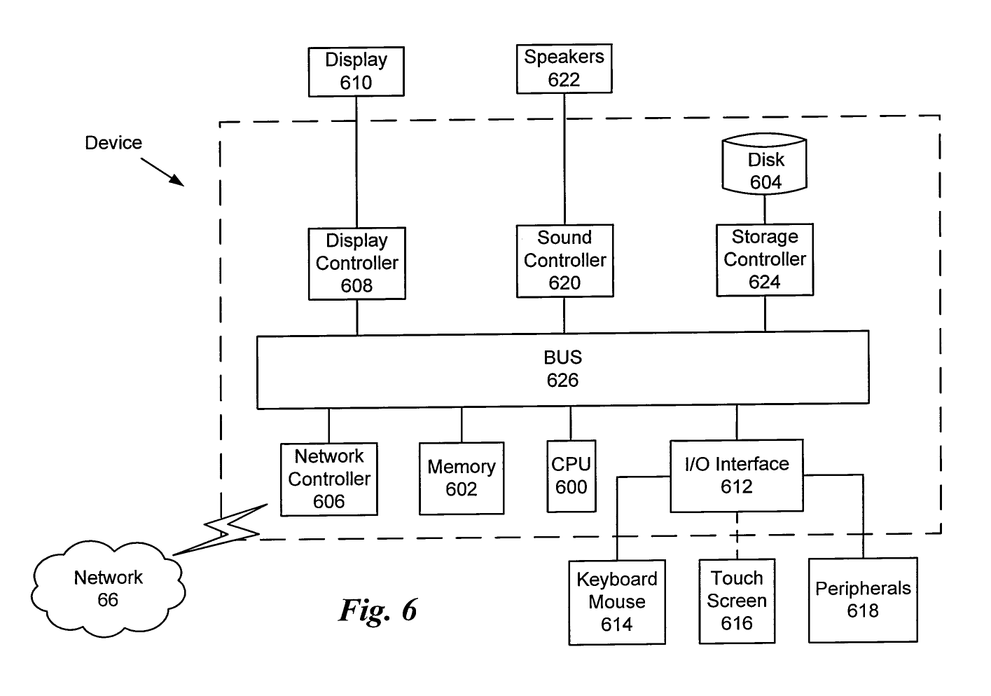

Next, a hardware description of the contract creation computing system, according to exemplary embodiments is described with reference to FIG. 6. In FIG. 6, the contract creation computing system includes a CPU 600 which performs the processes described above. The process data and instructions may be stored in memory 602. The contract tables illustrated in Tables 1-3 above and the flow chart 500 are generated by the CPU 600 and stored in memory 602. These processes and instructions may also be stored on a storage medium disk 604 such as a hard drive (HDD) or portable storage medium or may be stored remotely. Further, the claimed embodiments are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the contract creation computing system communicates, such as a server or computer.

Further, the claimed embodiments may be provided as a utility application, background daemon, or component of an operating system, or combination thereof, executing in conjunction with CPU 600 and an operating system such as Microsoft Windows 7, UNIX, Solaris, LINUX, Apple MAC-OS and other systems known to those skilled in the art.

CPU 600 may be a Xenon or Core processor from Intel of America or an Opteron processor from AMD of America, or may be other processor types that would be recognized by one of ordinary skill in the art. Alternatively, the CPU 600 may be implemented on an FPGA, ASIC, PLD or using discrete logic circuits, as one of ordinary skill in the art would recognize. Further, CPU 600 may be implemented as multiple processors cooperatively working in parallel to perform the instructions of the inventive processes described above.

The contract creation computing system in FIG. 6 also includes a network controller 606, such as an Intel Ethernet PRO network interface card from Intel Corporation of America, for interfacing with network 66. As can be appreciated, the network 66 can be a public network, such as the Internet, or a private network such as an LAN or WAN network, or any combination thereof and can also include PSTN or ISDN sub-networks. The network 66 can also be wired, such as an Ethernet network, or can be wireless such as a cellular network including EDGE, 3G and 4G wireless cellular systems. The wireless network can also be WiFi, Bluetooth, or any other wireless form of communication that is known.

The contract creation computing system further includes a display controller 608, such as a NVIDIA GeForce GTX or Quadro graphics adaptor from NVIDIA Corporation of America for interfacing with display 610, such as a Hewlett Packard HPL2445w LCD monitor. A general purpose I/O interface 612 interfaces with a keyboard and/or mouse 614 as well as a touch screen panel 616 on or separate from display 610. General purpose I/O interface 612 also connects to a variety of peripherals 618 including printers and scanners, such as an OfficeJet or DeskJet from Hewlett Packard.

A sound controller 620 is also provided in the contract creation computing system, such as Sound Blaster X-Fi Titanium from Creative, to interface with speakers/microphone 622 thereby providing sounds and/or music.

The general purpose storage controller 624 connects the storage medium disk 604 with communication bus 626, which may be an ISA, EISA, VESA, PCI, or similar, for interconnecting all of the components of the contract creation computing system. A description of the general features and functionality of the display 610, keyboard and/or mouse 614, as well as the display controller 608, storage controller 624, network controller 606, sound controller 620, and general purpose I/O interface 612 is omitted herein for brevity as these features are known.

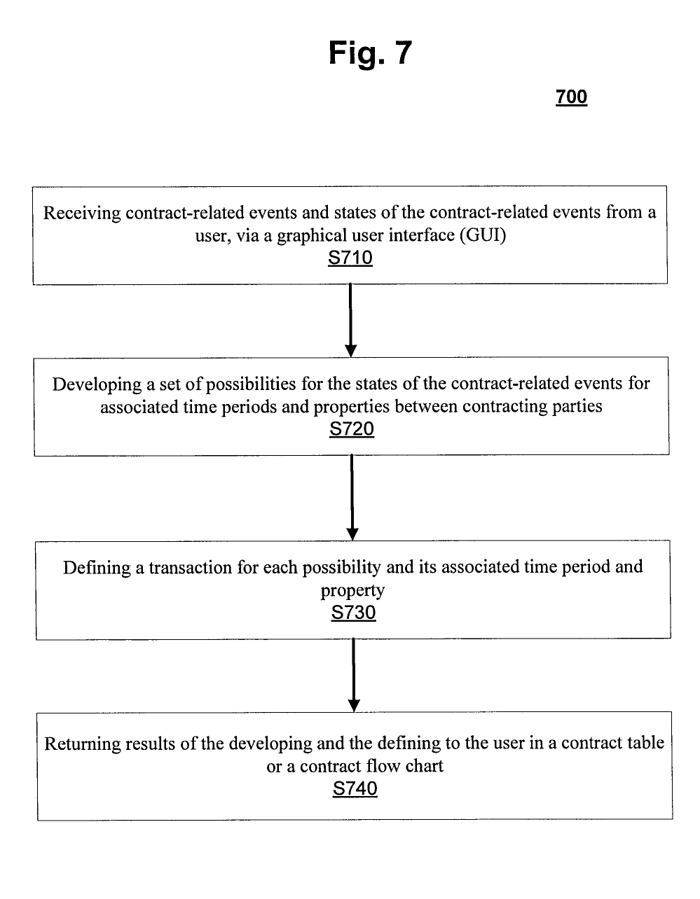

FIG. 7 is a flow diagram for a computer-implemented method of forming a contract between two or more parties 700. Contract-related events and states of the contract-related events are received from a user, via a GUI in step 710. An event is a step in the process of the contract. An event is a division of eventuality into states; the number of states is the number of degrees of an event. For example, an event can be “weather.” The “weather” event may have four different states or degrees, such as 1) warm and sunny, 2) cold and sunny, 3) raining, and 4) snowing, but additional degrees could be used. A set of possibilities for all the states of the contract-related events is developed in step 720. Each possibility is developed for a particular time period and type of property between contracting parties. A second event might be “painting,” where a contract is made to paint the exterior of a building. Three possible states of “painting” could be: 1) painting satisfactorily completed, 2) work not completed, and 3) completed work is unsatisfactory. Therefore, a set of possibilities would be developed for each possible combination of the four states of “weather” and the three states of “painting.” In addition, any relevant compound possibilities will be developed by the contract creation computing system 100.

A transaction for each possibility and its associated time period and property are defined in step 730. Examples of a property include, but are not limited to money, personal property, and real property. However, any type of legally recognized property can be used in a contract. In the above example, let us say that the weather was warm and sunny and the painting was satisfactorily completed in the agreed-upon period of time. A transaction might be a transfer of $5000 from the owner of the building to the contractor/painter. The results of the developing step and the defining step are returned to the user in a contract table, via a graphical user interface (GUI) of a computing device in step 740. The returned results display a direction of transfer for each transaction between the contracting parties. In the example above, the transfer of $5000 was made from the owner to the contractor. The displayed results also display the specific unit of property to be transferred, such as money in the example above. Results can be returned in a contract table format, such as the contract table illustrated in Tables 1 and 3. Results can also be returned in a contract flow chart, such as the flow charts illustrated in FIGS. 3-5.

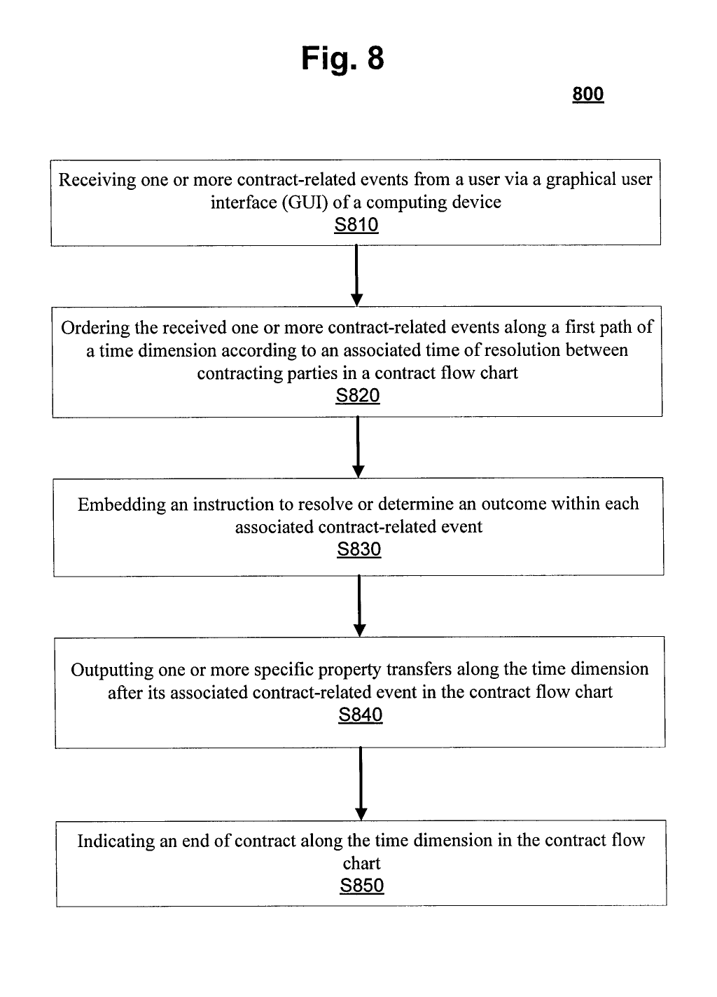

FIG. 8 is a flow diagram for a computer-implemented method of developing a contract flow chart 800. One or more contract-related events are received from a user, via a GUI of a computing device in step 810. The received contract-related events are ordered along a first path of a time dimension in step 820. The events are ordered according to an associated time of resolution between contracting parties in a contract flow chart. An instruction is embedded within each associated contract-related event in step 830. The instruction contains information or instructions needed to resolve or determine an outcome. The instruction could also contain the different states of that particular event.

One or more specific property transfers are outputted along the time dimension in the contract flow chart in step 840. This occurs after the associated contract-related event in the time dimension. The specific property transfer could also be made in response to a user selection of an event. In the above painting example, the user would indicate that the painting had been satisfactorily completed. In response, a specific property transfer of $5000 from the owner to the contractor/painter would be outputted in the time dimension. An end of contract is also indicated along the time dimension in the contract flow chart in step 850.

An embodiment includes multiple paths along the time dimension. As an example, an event may require a decision, in which a first path is taken for an affirmative decision and a second path is taken for a negative decision. The first path and the second path would continue along the time dimension concurrently until the end of each path was reached. Another embodiment includes constructing a contract table containing all of the data from the developed contract flow chart as a background process of a computing processor.

A contract creation computing system is used to implement the embodiments described herein, such as the system illustrated in FIG. 1. A server 4 contains a combination of hardware and software components to process contract data between contracting parties. The contract data contains one or more contract-related events that are positioned along a time line dimension according to an associated time of resolution by the server 4 from a start of a contract to an end of the contract between the contracting parties. A database 6 stores the contract data sent to and received from the server 4. A computing client machine, such as the computing device 2 or the mobile device 8 has a GUI to input the contract data and to receive results of the server 4. One or more specific property transfers between the contracting parties for a specific unit of property are outputted along the time line dimension after its associated contract-related event, via the server 4.

In one example, the received results are presented as a contract table. The contract table includes one or more rows that constitute a set of mutually exclusive and collectively exhaustive possibilities. A possibility is an individual state or degree of a contract-related event. The contract table also includes one or more columns showing the specific property supplied by each of the contracting parties to be transferred within associated time periods. The contract table also includes one or more cells showing a transfer of title to a given property for a particular future possibility.

In a second example, the received results are presented as a contract flow chart. The contract flow chart includes designated boxes to represent different events and output property transfer conditioned on these events.

Embodiments described herein for contract creation computing systems and methods help contracting parties increase the total value created from a transaction. For example, instead of negotiating the amount of property transfer in a given possibility, the contracting parties can negotiate property transfers in multiple future possibilities by inputting their indifference curves. The contract creation computing system would suggest a set of transfers that maximizes the total value created. In another example, for a given contract structured as a possibility tree with a resulting property transfer, the contract creation computing system would help contracting parties estimate the value of a transaction for a given specific contract by calculating the expected value of the transaction. This requires additional user input, such as the probability of each possibility, the party's intrinsic value in each possibility, and the value of the assets being transferred. The contract creation computing system can help parties aggregate data to estimate the probabilities of different events.

The foregoing discussion discloses and describes merely exemplary embodiments of the present invention. As will be understood by those skilled in the art, the present invention may be embodied in other specific forms without departing from the spirit or essential characteristics thereof Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

1. A computer-implemented method of forming a contract between two or more parties, the computer-implemented method comprising:
receiving contract-related events and states of the contract-related events from a user, via a graphical user interface (GUI);
developing, via a processor, a set of possibilities for the states of the contract-related events for associated time periods and properties between contracting parties;
defining a transaction for each possibility and its associated time period and property; and
returning results of the developing and the defining to the user in a contract table or a contract flow chart.

2. The computer-implemented method of claim 1, wherein the properties include one or more of money, personal property, real property, or a service.

3. The computer-implemented method of claim 1, wherein the returned results display a direction of transfer for each transaction between the contracting parties.

4. The computer-implemented method of claim 3, wherein the returned results display a specific unit of property to be transferred for each transaction between the contracting parties.

5. The computer-implemented method of claim 1, wherein the contract table includes:
one or more rows that constitute a set of mutually exclusive and collectively exhaustive possibilities;
one or more columns showing the properties supplied by the contracting parties to be transferred within associated time periods; and
one or more cells showing a transfer of title to a given property for a particular future possibility.

6. The computer-implemented method of claim 1, further comprising:
ordering the received contract-related events along a first path of a time dimension according to an associated time of resolution between the contracting parties;
embedding, via the processor, an instruction to resolve or determine an outcome within each associated contract-related event; and
indicating an end of contract along the time dimension.

7. A computer-implemented method of developing a contract flow chart, the computer-implemented method comprising:
receiving one or more contract-related events from a user via a graphical user interface (GUI) of a computing device;
ordering the received one or more contract-related events along a first path of a time dimension according to an associated time of resolution between contracting parties in a contract flow chart;
embedding, via a processor, an instruction to resolve or determine an outcome within each associated contract-related event;
outputting one or more specific property transfers along the time dimension after its associated contract-related event has been resolved in the contract flow chart; and
indicating an end of contract along the time dimension in the contract flow chart.

8. The computer-implemented method of claim 7, further comprising:
assigning a second path along the time dimension at a point of divergence from one of the contract-related events.

9. The computer-implemented method of claim 7, wherein the embedded instruction includes multiple states of the contract-related event.

10. The computer-implemented method of claim 7, further comprising:
receiving a selection of an outcome of one of the contract-related events from the user.

11. The computer-implemented method of claim 10, further comprising:
outputting an associated resulting property transfer along the time dimension after the receiving a selection.

12. The computer-implemented method of claim 7, wherein the one or more specific property transfers indicates a direction of transfer between the contracting parties and a specific unit of property to be transferred.

13. The computer-implemented method of claim 7, further comprising:
constructing a contract table containing data from the contract flow chart in a background of the processor.

14. The computer-implemented method of claim 7, wherein the contract flow chart includes:
a time line dimension extending from a start of a contract to an end of the contract;
one or more contract-related events;
one or more states for each of the one or more contract-related events;
one or more specific property transfers between contracting parties for a specific unit of property; and
embedded instructions that include a definition and associated states of the contract-related event,
wherein the one or more contract-related events are ordered along the time line dimension according to an associated time of resolution between the contracting parties, and each of the one or more specific property transfers are outputted along the time line dimension after its associated one or more contract-related events, via the processor.

15. The computer-generated contract flow chart of claim 14, further comprising:
a library containing a plurality of contract-related events for selection by a user.

16. A contract creation computing system, comprising:
a processing server containing a combination of hardware and software components to process contract data between contracting parties, wherein the contract data contains one or more contract-related events that are positioned along a time line dimension according to an associated time of resolution by the processing server from a start of a contract to an end of the contract between the contracting parties;
a database storing the contract data sent to and received from the processing server; and
a computing client machine having a graphical user interface to input the contract data and to receive results of the processing server,
wherein one or more specific property transfers between the contracting parties for a specific unit of property are outputted along the time line dimension after its associated contract-related event, via the processing server.

17. The contract creation computing system of claim 16, wherein the received results are presented as a contract table, the contract table including:
one or more rows that constitute a set of mutually exclusive and collectively exhaustive possibilities;
one or more columns showing the specific property supplied by each of the contracting parties to be transferred within associated time periods; and
one or more cells showing a transfer of title to a given property for a particular future possibility.

18. The contract creation computing system of claim 16, wherein the received results are presented as a contract flow chart, the contract flow chart including:
a designated box for an instruction type of contract-related event;
a decision box when multiple routes are designated thereafter;
embedded instructions that include a definition and associated states for each of the contract-related events; and
a direction of transfer for each specific property transfer.

19. The contract creation computing system of claim 16, wherein the one or more specific property transfers are outputted after receiving a selection of an outcome of one of the contract-related events.
